(19) United States
(12) Patent Application Publication
(10) Pub. No.: US 2013/0263801 A1
(43) Pub. Date: Oct. 10, 2013

(54) THERMOSTAT

(71) Applicants: HYUNDAI MOTOR COMPANY, Seoul (KR); KIA MOTORS CORPORATION, Seoul (KR); INZICONTROLS CO., LTD., Siheung-si (KR)

(72) Inventors: Philgi LEE, Suwon-si (KR); Gyuhwan KIM, Suwon-si (KR); Jae Suk PARK, Suwon-si (KR); Yong Jeong KIM, Ansan-si (KR)

(73) Assignees: Hyundai Motor Company, Seoul (KR); Inzicontrols Co., Ltd., Siheung-si (KR); Kia Motors Corporation, Seoul (KR)

(21) Appl. No.: 13/728,754

(22) Filed: Dec. 27, 2012

(30) Foreign Application Priority Data
Apr. 6, 2012 (KR) 10-2012-0036338

(51) Int. Cl. F01P 7/16; G05D 7/00

(52) U.S. Cl. CPC F01P 7/165; G05D 7/00
USPC 123/41.08; 137/468; 137/872

(57) ABSTRACT

A thermostat apparatus may include a valve body including a first valve formed to open or close a first passage thereon, and a second valve integrally connected to the first valve and opening or closing a second passage, an elastic member that elastically biases the valve body toward the first passage such that the first valve closes the first passage and the second valve opens the second passage, and a drive member that selectively pushes the valve body toward the second passage such that the first valve opens the first passage and the second valve closes the second passage.

### CROSS-REFERENCE TO RELATED APPLICATION

The present application claims priority to Korean Patent Application No. 10-2012-0036338 filed on Apr. 6, 2012, the entire contents of which is incorporated herein for all purposes by this reference.

### BACKGROUND OF THE INVENTION

1. Field of the Invention

The present invention relates to a thermostat that changes a passage of a coolant depending on the temperature of the coolant and actively controls the coolant temperature to prevent overheating thereof.

2. Description of Related Art

A thermostat for a vehicle is disposed between an engine and a radiator, is automatically opened/closed by the temperature variation of coolant to adjust the flow rate of the coolant, and therefore the temperature of the coolant is controlled in a predetermined range.

A mechanical thermostat expands wax depending on the temperature of the coolant, and the expanding force of the wax makes a piston move the valve of the thermostat.

The mechanical thermostat is operated in a predetermined opening/closing temperature of the coolant to open/close the valve only in a predetermined temperature condition, and therefore the mechanical thermostat does not actively move against changes of the driving circumstances of the vehicle.

Accordingly, an electrical thermostat has been introduced to complements the drawback of the mechanical thermostat, and the electrical thermostat is operated to sustain the coolant temperature in an optimized range.

The electrical thermostat actively controls the coolant temperature of the engine according to the driving circumstances such as the load level of the vehicle to sustain the optimized coolant temperature, and the electrical thermostat can improve fuel consumption efficiency and reduce exhaust gas.

Meanwhile, three coolant passages are formed in the electrical thermostat and the mechanical thermostat as an example. A first passage is connected to a radiator, a second passage is connected to a coolant outlet of the engine, and a third passage is connected to a coolant inlet of the engine. Here, the coolant pump can be disposed between the third passage and the coolant inlet.

In this case, the first valve of the thermostat opens/closes the first passage, the second valve opens/closes the second passage, and the third passage is opened. Further, a guide can be disposed to guide the movement of the first and second valve.

As described above, when the first valve, the second valve, and the guide are separately disposed, the number of components is increased and the structure can be complicated.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a thermostat having advantages of making the structure of a first valve, a second valve, and a guide, which open/close a passage of a coolant become simple, and reducing the number of components.

Further, the present invention provides a thermostat that actively controls the coolant temperature of the engine and improves the performance of the engine.

In an aspect of the present invention, a thermostat apparatus may include a valve body having a first valve formed to open or close a first passage thereon, and a second valve integrally connected to the first valve and opening or closing a second passage, an elastic member that elastically biases the valve body toward the first passage such that the first valve closes the first passage and the second valve opens the second passage, and a drive member that selectively pushes the valve body toward the second passage such that the first valve opens the first passage and the second valve closes the second passage.

An O-ring groove is formed in an outer circumference of the first valve at a part corresponding to an inner circumference surface of the first passage and a valve O-ring is disposed in the O-ring groove.

A mounting space is formed along a central portion of the valve body, wherein the drive member is inserted into the mounting space, and wherein the drive member may include a piston that selectively pushes a piston support portion that is integrally formed with the second valve.

The drive member selectively pushes the valve body to make the second valve close the second passage while an end portion of the valve body is inserted into the second passage.

The valve body may include frame elements that are disposed with a distance in a circumferential direction based on the mounting space and connects the first valve and the second valve.

A first reinforcement portion is integrally formed with the frame elements between the first valve and the second valve in a circumferential direction of the valve body, wherein a second reinforcement portion is integrally formed with the valve body at a part that is slidably inserted into the second passage in a circumferential direction of the valve body.

The second reinforcement portion is formed at a lower side of the second valve.

A diameter of the second passage is larger than a diameter of the second reinforcement portion and smaller than a diameter of the second valve.

The second reinforcement portion may have a circular ring shape corresponding to an interior circumference of the second passage.

The first passage is connected to a radiator, wherein the second passage is connected to a coolant outlet of an engine, and wherein the third passage is connected to a coolant inlet of the engine.

The thermostat according to an exemplary embodiment of the present invention has a structure in which the first valve, the second valve, and the guide are integrally formed such that the overall structure becomes simple and the number of components is reduced.

Further, the thermostat according to an exemplary embodiment of the present invention actively controls the temperature of the coolant circulating in the engine to improve the fuel consumption efficiency and the performance of the engine.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a partial cross-sectional view of a thermostat that is provided on an engine according to an exemplary embodiment of the present invention.

FIG. 2 is a side view showing that a glow plug is mounted on a valve body in a thermostat according to an exemplary embodiment of the present invention.

FIG. 3 is a perspective view showing a valve body in a thermostat according to another exemplary embodiment of the present invention.

FIG. 4 is a partial cross-sectional view showing that a thermostat is operated in an engine according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

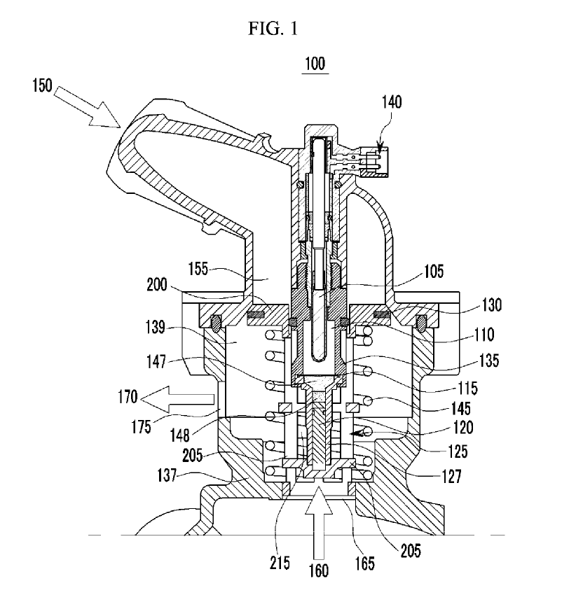

FIG. 1 is a partial cross-sectional view of a thermostat that is provided on an engine according to an exemplary embodiment of the present invention.

Referring to FIG. 1, an engine includes a radiator 150, a coolant outlet 160 of an engine, a coolant inlet 170 of an engine, and a thermostat 100.

The thermostat 100 includes a thermostat case 137, and a first passage 155 is formed to be connected to the radiator 150, a second passage 165 is formed to be connected to the coolant outlet 160, and a third passage 175 is connected to the coolant inlet 170 in the thermostat case 137.

A coolant pump in an exemplary embodiment of the present invention is disposed between the third passage 175 and the coolant inlet 170 to circulate coolant from the thermostat 100 to the engine.

As shown in drawings, the first passage 155 is formed at an upper side, the second passage 165 is formed at a lower side, and the third passage 175 is formed between the first and second passages 155 and 165.

A joining space 139 is formed in the thermostat case 137 to be connected to the first passage 155, the second passage 165, and the third passage 175, and a valve body 125 is disposed in the joining space 139.

A first valve 200 is integrally formed at an upper end portion of the valve body 125 to selectively close the first passage 155, and a second valve 205 is integrally formed at a lower end portion of the valve body 125 to selectively close the second passage 165. Further, a valve O-ring 130 is mounted along an exterior circumference of the first valve 200 to contact the interior circumference of the first passage 155.

A main spring 145 is disposed inside the thermostat case 137, and an upper end portion of the main spring 145 elastically supports the lower end portion of the first valve 200 in an upper direction, and a lower end portion of the main spring 145 is supported by an inner side of the thermostat case 137.

The main spring 145 has a coil spring structure, and the valve body is inserted into the coil of the main spring 145 except the first valve 200 and the part that that is inserted into the second passage 165.

Further, a mounting space is formed along a central portion of the valve body 125 from an upper end side to a lower end side, and a drive member that moves the valve body 125 is inserted into the mounting space 215.

The drive member includes a piston support portion 225, a piston 120, a rubber piston 148, a piston guide 127, a semi-fluid 147, a diaphragm 115, wax 110, a wax case 135, and a glow plug 105, wherein the glow plug 105 is electrically connected to a connector 140.

The piston support portion 225 is formed at a central portion of the second valve 205 that is formed at a lower end portion of the valve body 125.

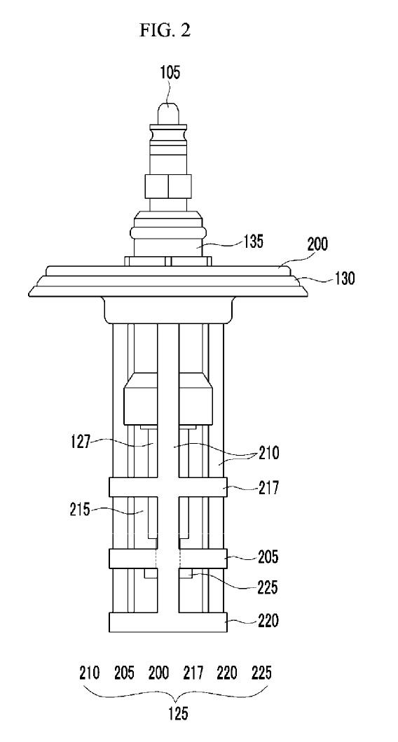

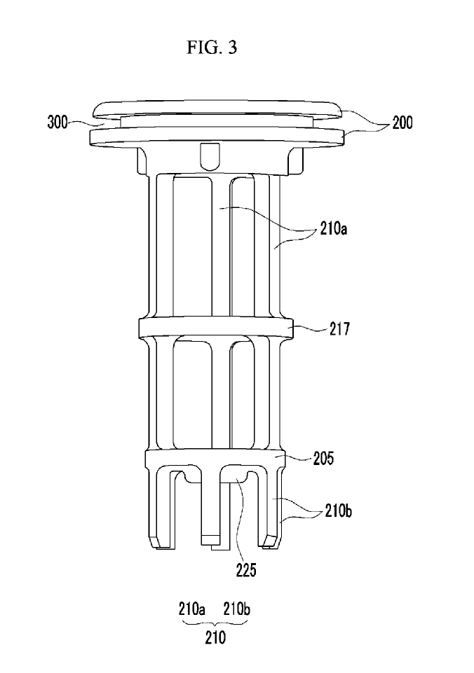

FIG. 2 is a side view showing that a glow plug is mounted on a valve body in a thermostat according to an exemplary embodiment of the present invention, and FIG. 3 is a perspective view showing a valve body in a thermostat according to another exemplary embodiment of the present invention.

Referring to FIG. 2 and FIG. 3, an O-ring groove 300 is formed at an exterior circumference of the first valve 200 and the valve O-ring 130 is disposed in the groove 300.

Further, a mounting space 215 is formed at a central portion of the valve body 125 along the length direction of the valve body 125, and the piston guide 127, the wax case 135, and the glow plug 105 of the drive member are inserted into the mounting space 215.

The valve body 125 includes frame elements 210 that are formed with a distance along the circumference direction such that the drive member that is inserted into the mounting space 215 of the valve body 125 can be shown from the outside of the valve body, and the first valve 200 and the second valve 205 are integrally formed with the frame elements 210.

Referring to FIG. 2, the valve body 125 includes three frame elements 210. The number of frame elements 210 can be varied to two or six according to the design specification.

The piston support portion 225 is formed at a central portion of the second valve 205 to correspond to the piston 120, and the piston support portion 225 is integrally formed with the second valve 205.

A second reinforcement portion 220 is formed at a lower side of the second valve 205 and is formed to integrally connect a lower end portion of the frame element 210 in a circumference direction of the valve body 125, and a first reinforcement portion 217 is formed between the second valve 205 and the first valve 200 to integrally connect the frame element 210 in a circumference direction of the valve body 125.

As shown in drawings, the first reinforcement portion 217, the second valve 205, and the second reinforcement portion 220 have a circular ring shape that integrally connects the frame elements 210 in a circumference direction.

Further, the second reinforcement portion has a circular ring shape corresponding to the second passage, and the exterior circumference of the second reinforcement portion can slide with the interior circumference of the second passage.

The relative position of the first reinforcement portion 217, the second valve 205, and the second reinforcement portion 220 can be predetermined by the design specification. Further, as shown in FIG. 3, the second reinforcement portion 220 can be eliminated.

Referring to FIG. 1, a lower end portion of the frame element 210 of the valve body 125 is inserted into the second passage 165. Accordingly, the valve body 125 is guided by the second passage 165.

Referring to FIG. 3, three first frame elements 210a are formed at an upper side of the second valve 205 and six second frame elements 210b are formed at a lower side of the second valve 205.

The six second frame elements 210b that are formed at a lower side of the second valve 205 are parts that can be inserted into the second passage 165. As described above, the number of second frame elements is larger than that of the first frame elements 210a. Accordingly, the valve body 125 is securely guided by the second passage 165.

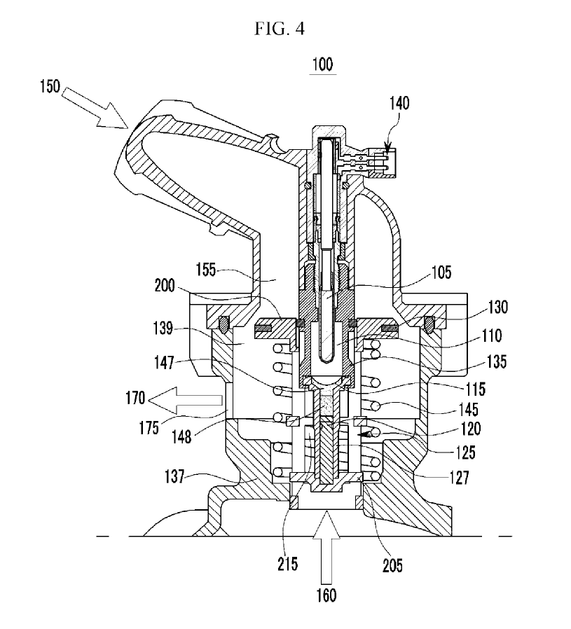

FIG. 4 is a partial cross-sectional view showing that a thermostat is operated in an engine according to an exemplary embodiment of the present invention.

Referring to FIG. 4, the coolant that is supplied through the coolant outlet 160 joins the joining space 139 and then is supplied to the coolant inlet 170. Further, when the temperature of the coolant is increased or the current is supplied to the glow pug, the temperature of the wax 110 is increased.

While the temperature of the wax is increased, the wax 110 is expanded to expand the diaphragm 115 in a lower direction.

If the diaphragm 115 is expanded in a lower direction, the rubber piston 148 and the piston 120 is moved downward thereby and the piston 120 pushes the piston support portion 225 of the valve body 125 in a lower direction.

If the piston support portion 225 and the valve body 125 are moved downward, the first valve 200 opens the first passage 155 and the second valve 205 closes the second passage 165 or reduces the opening rate of the second passage 165.

Accordingly, the flow rate that is supplied through the second passage 165 is increased and the flow rate that is supplied through the first passage 155 is increased. Because the first passage 155 is connected to the radiator 150, the amount of the coolant that is cooled by the radiator 150 is increased. Accordingly, the temperature of the entire coolant is not raised or is lowered to be effectively sustained in a predetermined range.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A thermostat apparatus, comprising:
a valve body including:
a first valve formed to open or close a first passage thereon; and
a second valve integrally connected to the first valve and opening or closing a second passage;
an elastic member that elastically biases the valve body toward the first passage such that the first valve closes the first passage and the second valve opens the second passage; and
a drive member that selectively pushes the valve body toward the second passage such that the first valve opens the first passage and the second valve closes the second passage.

2. The thermostat apparatus of claim 1, wherein an O-ring groove is formed in an outer circumference of the first valve at a part corresponding to an inner circumference surface of the first passage and a valve O-ring is disposed in the O-ring groove.

3. The thermostat apparatus of claim 1,
wherein a mounting space is formed along a central portion of the valve body,
wherein the drive member is inserted into the mounting space, and
wherein the drive member includes a piston that selectively pushes a piston support portion that is integrally formed with the second valve.

4. The thermostat apparatus of claim 3, wherein the drive member selectively pushes the valve body to make the second valve close the second passage while an end portion of the valve body is inserted into the second passage.

5. The thermostat apparatus of claim 3, wherein the valve body includes frame elements that are disposed with a distance in a circumferential direction based on the mounting space and connects the first valve and the second valve.

6. The thermostat apparatus of claim 4,
wherein a first reinforcement portion is integrally formed with the frame elements between the first valve and the second valve in a circumferential direction of the valve body, and
wherein a second reinforcement portion is integrally formed with the valve body at a part that is slidably inserted into the second passage in a circumferential direction of the valve body.

7. The thermostat apparatus of claim 6, wherein the second reinforcement portion is formed at a lower side of the second valve.

8. The thermostat apparatus of claim 6, wherein a diameter of the second passage is larger than a diameter of the second reinforcement portion and smaller than a diameter of the second valve.

9. The thermostat apparatus of claim 6, wherein the second reinforcement portion has a circular ring shape corresponding to an interior circumference of the second passage.

10. The thermostat apparatus of claim 1,
wherein the first passage is connected to a radiator,
wherein the second passage is connected to a coolant outlet of an engine, and
wherein the third passage is connected to a coolant inlet of the engine.
